(19) United States
(12) Patent Application Publication
(10) Pub. No.: US 2020/0073379 A1
(43) Pub. Date: Mar. 5, 2020

(54) SYSTEMS AND METHODS FOR CONFIRMING THAT A DRIVER HAS CONTROL OF A VEHICLE

(71) Applicant: TOYOTA RESEARCH INSTITUTE, INC., Los Altos, CA (US)

(72) Inventors: Michael L. ELKINS, Framingham, MA (US); Thor LEWIS, Sunnyvale, CA (US)

(73) Assignee: TOYOTA RESEARCH INSTITUTE, INC., Los Altos, CA (US)

(21) Appl. No.: 16/118,876

(22) Filed: Aug. 31, 2018

(51) Int. Cl. G05D 1/00; B60Q 9/00; B60W 30/182; B60W 50/14; B60W 50/16

(52) U.S. Cl. CPC G05D 1/0061; B60Q 9/00; B60W 30/182; B60W 50/14; B60W 2050/146; G05D 2201/0213; B60W 2540/22; B60W 2050/143; B60W 50/16

(57) ABSTRACT

An autonomous vehicle includes processing circuitry configured to receive autonomous control of the vehicle. Additionally, the autonomous vehicle is configured to determine if the operator is ready to take control of the vehicle, maintain autonomous control of the vehicle when the operator is not ready to take control of the vehicle, and pass manual control of the vehicle to the operator when the operator is ready to take control of the vehicle. Further, the autonomous vehicle is configured to control the autonomous vehicle in a predetermined driving pattern while the vehicle is being operated autonomously, determine if the operator reacts in an expected way in response to the vehicle being controlled in the predetermined way, maintain autonomous control of the vehicle when the operator does not react in the expected way, and pass manual control of the vehicle to the operator when the operator does react in the expected way.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

With the rise of fully autonomous and semi-autonomous vehicles, new safety concerns have also come up. For example, there can be certain situations where an autonomous vehicle may determine that a human should take manual control of the vehicle. In these circumstances, the autonomous vehicle must confirm that the human is able to safely take control of the vehicle before passing manual control to the human.

### SUMMARY

According to aspects of the disclosed subject matter, one aspect of the present disclosure relates to a system configured for confirming that a driver is ready to take control of a vehicle. The system may include one or more hardware processors configured by machine-readable instructions. The processing circuitry may be configured to receive autonomous control of the vehicle. The vehicle may be capable of autonomous operation. The processing circuitry may be configured to determine if the driver is ready to take control of the vehicle. Additionally, the processing circuitry may be configured to maintain autonomous control of the vehicle when the driver is not ready to take control of the vehicle. Further, the processing circuitry may be configured to pass manual control of the vehicle to the driver when the driver does have control of the vehicle.

Another aspect of the present disclosure relates to a method for confirming that a driver is ready to take control of a vehicle. The method may include receiving, via the processing circuitry, autonomous control of the vehicle. The method may further include determining if the driver is ready to take control of the vehicle, maintaining autonomous control of the vehicle when the driver is not ready to take control of the vehicle, and passing manual control of the vehicle to the driver when the driver is ready to take control of the vehicle.

Yet another aspect of the present disclosure relates to a non-transient computer-readable storage medium having instructions embodied thereon, the instructions being executable by one or more processors to perform a method for confirming that a driver is ready to take control of a vehicle. The method may include receiving, via the processing circuitry, autonomous control of the vehicle. The method may further include determining if the driver is ready to take control of the vehicle, maintaining autonomous control of the vehicle when the driver is not ready to take control of the vehicle, and passing manual control of the vehicle to the driver when the driver is ready to take control of the vehicle.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary system configured for confirming that a driver is ready to take control of a vehicle according to one or more aspects of the disclosed subject matter;

FIG. 2 illustrates a perspective view of a dashboard of an autonomous vehicle according to one or more aspects of the disclosed subject matter;

FIG. 3 is an algorithmic flow chart of a method for confirming that an operator is ready to take control of a vehicle according to one or more aspects of the disclosed subject matter;

FIG. 4 is an algorithmic flow chart of a method for determining if an operator is reacting in an expected way according to one or more aspects of the disclosed subject matter; and

FIG. 5 is an algorithmic flow chart of a method for confirming that a driver is ready to take control of a vehicle according to one or more aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.”

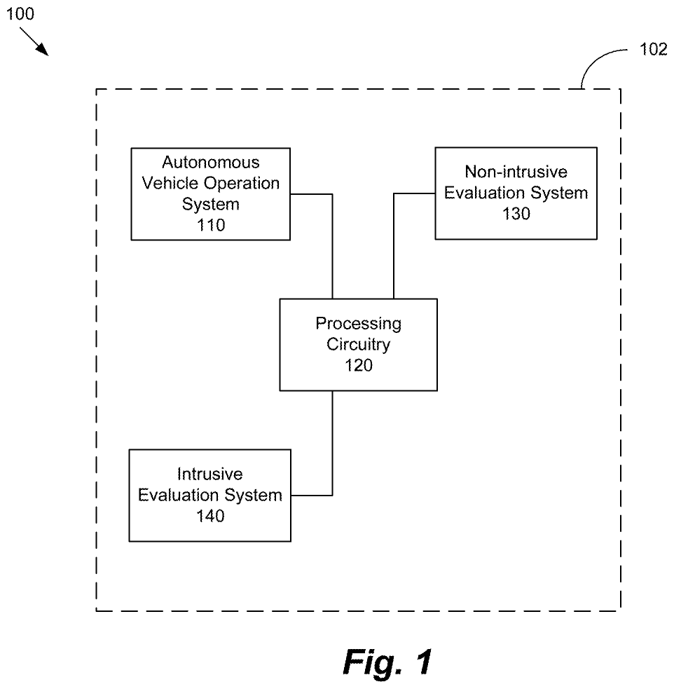

Referring now to the drawings, wherein like reference numerals designate identical or corresponding parts throughout the several views, FIG. 1 illustrates an exemplary system 100 configured for confirming that a driver has control of a vehicle according to one or more aspects of the disclosed subject matter. As will be discussed in more detail later, one or more methods according to various embodiments of the disclosed subject matter can be implemented using the system 100 or portions thereof. Put another way, system 100, or portions thereof, can perform the functions or operations described herein regarding the various methods or portions thereof (including those implemented using a non-transitory computer-readable medium storing a program that, when executed, configures or causes a computer to perform or cause performance of the described method(s) or portions thereof).

System 100 can include an autonomous vehicle operation system 110, processing circuitry 120 (which can include internal and/or external memory), a non-intrusive evaluation system 130, and an intrusive evaluation system 140. In an embodiment, the autonomous vehicle operation system 110, the processing circuitry 120, the non-intrusive evaluation system 130, and the intrusive evaluation system 140 can be implemented in a stand-alone apparatus 102. The stand-alone apparatus 102 can be an autonomous vehicle or a highly automated vehicle, for example, operated via the autonomous vehicle operation system 110 (e.g., imaging device, automated steering components, acceleration components, braking components, and the like). Additionally, the autonomous vehicle may still include controls for manual operation. For convenience and clarity in the description, the stand-alone apparatus 102 may be referred to herein as autonomous vehicle or vehicle, wherein the autonomous vehicle or vehicle may include both autonomous control and manual control capability.

Generally speaking, the processing circuitry 120 can confirm that an operator (e.g., driver/human controlling the operation of the vehicle) of the autonomous vehicle 102 is ready to take control of the autonomous vehicle 102 before control of the vehicle is passed from autonomous (i.e., computer control) to operator control (i.e., manual control). In one embodiment, the processing circuitry 120 may determine whether or not the operator is ready to take control of the autonomous vehicle 102 via the non-intrusive evaluation system 130. For example, the autonomous vehicle 102 may be under some form of autonomous control, and before control of the autonomous vehicle 102 is passed to a human driver, the processing circuitry should confirm that the operator is ready to take control of the autonomous vehicle 102 and is fully engaged with the operation of the autonomous vehicle 102.

For example, a driver may be sleeping, reading, daydreaming, or otherwise not paying attention/not fully engaged with the operation of the autonomous vehicle 102. In such cases, control of the autonomous vehicle 102 should remain with the vehicle computer (i.e., processing circuitry 120.

More specifically, the processing circuitry 120 may autonomously control the operation of the vehicle in a manner that causes the operator of the vehicle to react. If the driver of the vehicle reacts in an expected way, such as counteracting a movement of the vehicle caused by the processing circuitry 120, the processing circuitry 120 may determine that the operator is ready to take control of the autonomous vehicle 102 and it is appropriate to pass control of the vehicle to the operator (i.e., manual control). Accordingly, the system 100 provides a technique for confirming that the operator has control of the vehicle and is engaged without intrusively asking the operator if the operator has or is capable of manual control of the vehicle 102.

In other words, there may be situations where it is desirable for control of an autonomous or semi-autonomous vehicle to be passed from computer control (i.e., processing circuitry 120) to operator control (i.e., manual human operation). For example, processing circuitry 120 may take control of the vehicle 102 (i.e., automatically take autonomous control) to avoid an obstacle when the operator is not paying attention and misses the presence of the obstacle. After the processing circuitry 120 causes the autonomous vehicle 102 to avoid the obstacle, the processing circuitry 120 must determine whether or not the driver is engaged with the operation of the vehicle 102 prior to passing control of the vehicle 102 back over to the driver.

For example, the processing circuitry 120 can determine whether or not the driver is engaged and has control of the vehicle by controlling the vehicle autonomously in a predetermined pattern, and then evaluating how the driver reacts to the vehicle being driven autonomously in the predetermined pattern. The predetermined pattern may be any driving pattern that gains the attention of the driver and causes the driver to react by controlling the vehicle in an expected way. In one example, the predetermined pattern is such that the vehicle autonomously swerves back and forth within its lane. As another example, the predetermined pattern is lightly pulsing the brakes of the vehicle. As an additional example, the vehicle could behave as if it was “poorly tuned” to drive the car, reacting slower and less able to keep to the center of the road, similar to a novice driver.

The predetermined pattern will cause an engaged driver to counter the actions of the vehicle caused by the predetermined pattern. For example, a driver may not pay attention to an object in the road. In response, the processing circuitry 120 can take over control of the vehicle so that the vehicle may autonomously swerve into an adjacent lane to avoid the object and then return the vehicle to the proper lane automatically. Prior to returning control of the vehicle back over to the driver, the processing circuitry may evaluate whether or not the driver has control of the vehicle and is engaged by drifting back and forth in the lane. If the driver counteracts the drift using the steering wheel, the vehicle computer (i.e., processing circuitry) may confirm that the driver is ready to take control of the vehicle and is engaged. Manual control of the vehicle may be passed to the driver as a result. If the driver does not counteract the drifting, or overcorrects frantically, the vehicle computer may confirm that the driver is not ready to have control of the vehicle and is not engaged. In response to determining the driver is not ready or able to take manual control of the vehicle, the vehicle computer may retain autonomous control of the vehicle until it is confirmed that the driver is ready to take control and is engaged.

In some cases, the operator of the autonomous vehicle 102 may not be responding to the non-intrusive techniques offered by the non-intrusive evaluation system 130. For example, the operator may be sleeping, unconscious, or otherwise not currently able to respond to the non-intrusive evaluation system 130. In one embodiment, the processing circuitry 120 can alert the operator of the autonomous vehicle 102 via the intrusive evaluation system 140 that the operator can and/or needs to take manual control of the vehicle. The intrusive evaluation system 140 can include various techniques for gaining the operators attention including audio, tactile, and visual techniques. Additionally, one or more of these techniques can be combined when attempting to gain the operator's attention. Generally, in hands-free driving circumstances where processing circuitry 120 has autonomous control of the vehicle via the autonomous vehicle operation system 110, it may be desirable that the driver grasp the steering wheel and take over control of the vehicle from the processing circuitry 120. In this case, the driver should be notified in a clear and unambiguous manner that the operator should take manual control of the vehicle. More specifically, there may be situations where the vehicle computer determines that the human driver should take control of the vehicle. For example, the conditions may be such that the processing circuitry 120 determines that an autonomous driving confidence value is below a certain threshold and control of the vehicle should be passed from the vehicle computer to the human driver.

To gain the attention of the operator, the intrusive evaluation system 140 can use one or more alerts and/or messages. For example, the autonomous vehicle 102 can play an audio message instructing the driver that he or she needs to grasp the steering wheel and take control of the vehicle. Other alerts can include haptic feedback by vibration in the seat, steering wheel, floor, arm rests, and the like. Additionally, the alert to gain the attention of the driver can be one or more puffs of air directed at the driver (e.g., from the steering wheel, from the air vents, from the roof of the vehicle, etc.). The processing circuitry 120 can then confirm that the driver has engaged the vehicle by using sensors in the steering wheel, an imaging device monitoring the operator, receiving an audio cue from the operator (e.g., “I am taking manual control.”), and/or receiving input from the operator via a dedicated button in the vehicle. Once the sensors in the steering wheel (or other confirmation technique described herein) provide an indication that the driver has grasped the steering wheel, control of the vehicle is passed from the vehicle computer to the human driver. The vehicle may also produce a message indicating that control of the vehicle has been passed, and that the human driver is responsible for the control of the vehicle.

The processing circuitry 120 can carry out instructions to perform or cause performance of various functions, operations, steps or processes of the system 100. The processing circuitry 120 can be configured to store information in memory, operate the system 100, and receive and send information in the form of signal(s) from the autonomous vehicle operation system 110, the non-intrusive evaluation system 130, and the intrusive evaluation system 140.

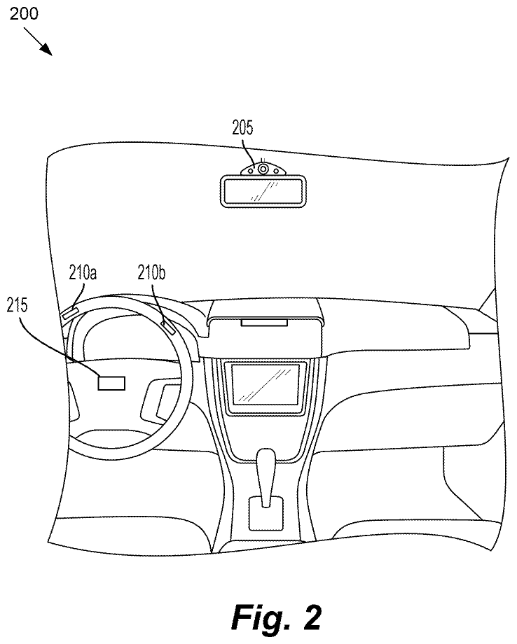

FIG. 2 illustrates a perspective view of a dashboard 200 of the autonomous vehicle 102 according to one or more aspects of the disclosed subject matter. The dashboard 200 can include an imaging device 205, sensors 210a, 210b, and an air alert device 215.

The imaging device 205 can be a camera, for example, configured to capture photos and/or video of the operator. The processing circuitry 120 can receive information (e.g., the photos and/or video) from the imaging device 205 and determine whether or not the operator is engaged and able to take manual control of the autonomous vehicle 102. For example, the imaging device 205 may be able to detect a head position of the operator (e.g., head angled down), which may correspond to operator looking down at their phone, sleeping, or looking straight ahead. The processing circuitry 120 may be able to identify whether or not the operator is engaged based on the head position. For example, when the operator's head is tilted down, they may not be ready to take manual control. Alternatively, if the operator is looking straight ahead, they may be ready to take manual control. Similarly, the imaging device 110 may be able to detect eye position and/or if the operator's eyes are closed longer than a predetermined amount of time (e.g., based on an average human blink). For example, if the operator's eyes are looking down (e.g., looking at their phone, reading, etc.), the operator may not be ready to take manual control. Alternatively, if the operator is looking straight ahead, they may be ready to take manual control.

The sensors 210a, 210b can be included in the intrusive evaluation system 140 such that the sensors 210a, 210b can be used to confirm when an operator has grasped the steering wheel and is ready to take manual control of the autonomous vehicle 102. It should be appreciated that the sensors 210a, 210b can be placed in various locations on the steering wheel that may be a natural grasping position for an operator. For example, an alternate location can be at “8 and 4” on the steering wheel rather than “10 and 2.”

The air alert device 215 can be configured to blow air at the operator (e.g., at the operator's face) to gain their attention as described herein as part of the intrusive evaluation system 140.

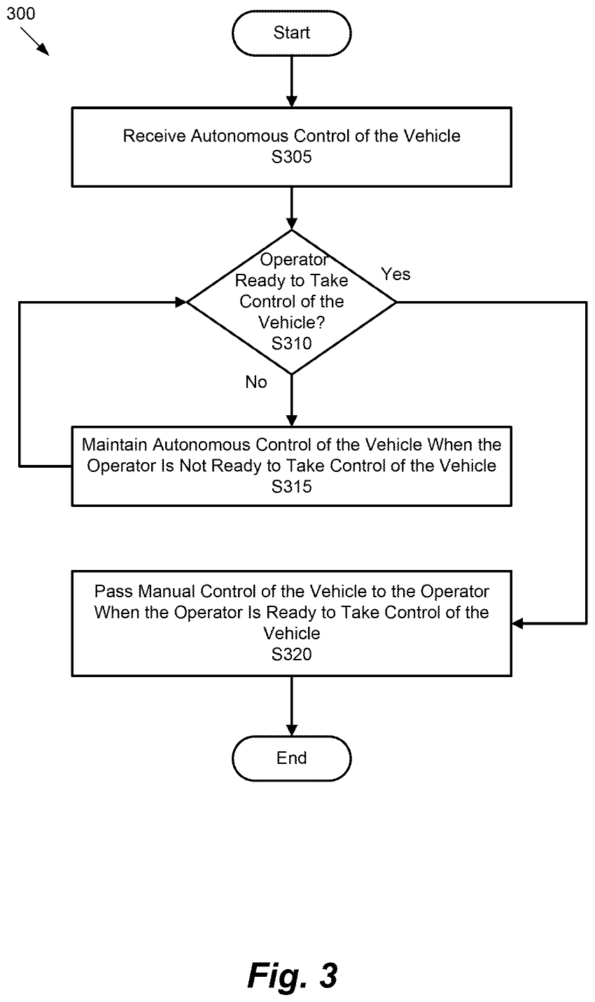

FIG. 3 is an algorithmic flow chart of a method 300 for confirming that an operator is ready to take control of a vehicle according to one or more aspects of the disclosed subject matter.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

In S305, the processing circuitry 120 can receive autonomous control of the vehicle. For example, the autonomous vehicle 102 may have been placed into an autonomous mode by the operator. Additionally, for example, the autonomous vehicle 102 may take autonomous control automatically to avoid a collision, avoid debris in the road, and the like.

In S310, it can be determined if the operator is ready to take control of the autonomous vehicle 102. For example, the operator may be ready to take control of the vehicle when the processing circuitry can confirm that the operator is engaged in vehicle operation and able to manually control the vehicle. If it is determined that the operator is ready to take control of the autonomous vehicle 102, then manual control of the autonomous vehicle 102 can be passed to the operator in S320. However, if it is determined that the operator does not have control of the autonomous vehicle 102, then autonomous control of the autonomous vehicle 102 can be maintained in S315 and the process can return to S310 to continue determining whether or not the operator has control of the autonomous vehicle 102.

In S315, autonomous control of the autonomous vehicle 102 can be maintained when the operator is not ready to have control of the autonomous vehicle 102. Additionally, the process can return to S310 to continue determining whether or not the operator has control of the autonomous vehicle 102.

In S320, manual control of the autonomous vehicle 102 can be passed to the operator when the operator is ready to take control of the autonomous vehicle 102. After manual control of the autonomous vehicle 102 is passed to the operator, the process can end.

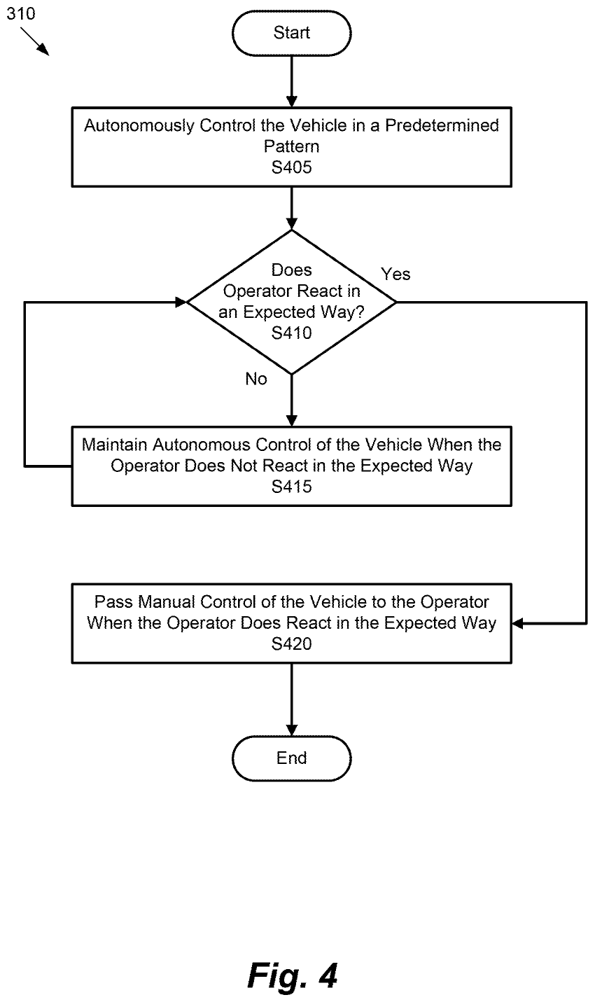

FIG. 4 is an algorithmic flow chart of a method 310 for determining if an operator is reacting in an expected way according to one or more aspects of the disclosed subject matter.

In S405, the autonomous vehicle 102 can be controlled autonomously in a predetermined pattern. In one example, the predetermined pattern can correspond to the autonomous vehicle 102 autonomously drifting back and forth within its lane. Alternatively, or additionally, as another example, the predetermined pattern can correspond to lightly pulsing the brakes of the autonomous vehicle 102. In other words, the autonomous vehicle 102 can be configured to use imperfect driving to encourage the operator to demonstrate better driving, thereby indicating to the autonomous vehicle 102 that the operator is ready to take control of the vehicle. In one example, the predetermined pattern can be continuous while waiting for the operator to react to the predetermined pattern. Alternatively, the predetermined pattern can be implemented at predetermined intervals (e.g., for 30 seconds every minute). Additionally, the predetermined intervals can be based on future predicted driving conditions, wherein dangerous future driving conditions correspond to a shorter predetermined interval because the operator needs to take manual control more urgently, and safe future driving conditions correspond to a longer predetermined interval because the operator does not need to take manual control urgently.

In S410, it can be determined if the operator reacts in an expected way. The expected way can correspond to counteracting the movement of the autonomous vehicle 102 initiated in S405. The predetermined pattern from S405 will cause an engaged driver to counter the actions of the autonomous vehicle 102 caused by the predetermined pattern. For example, if the autonomous vehicle 102 is drifting within its lane (e.g., a slow and controlled swerve within its lane), the operator of the vehicle may turn the wheel of the autonomous vehicle 102 to counteract the swerving, instinctively or consciously. In another example, if the autonomous vehicle 102 is pulsing the brakes as the predetermined pattern from S405, the operator may accelerate the autonomous vehicle 102 to counteract the pulsing brakes. If it is determined that the operator does react in the expected way in S410, manual control of the autonomous vehicle 102 can be passed to the operator in S420. However, if it is determined that the operator does not react in the expected way (e.g., the operator does not counteract the predetermined pattern of the autonomous vehicle 102 initiated in S405), autonomous control of the autonomous vehicle 102 can be maintained in S410.

In S415, autonomous control of the autonomous vehicle 102 can be maintained when the operator of the autonomous vehicle 102 does not react in the expected way. When the operator does not act in the expected way, the process can return to S410 to continue determining whether or not the operator reacts in the expected way based on the predetermined pattern initiated by the processing circuitry 120 of the autonomous vehicle 102 in S405.

In S420, manual control of the autonomous vehicle 102 can be passed to the operator when the operator does react in the expected way. Because the predetermined pattern will cause an engaged driver to counter the actions of the autonomous vehicle 102 caused by the predetermined pattern initiated in S405, the system 100 can be confident that the operator of the autonomous vehicle 102 can take manual control of the autonomous vehicle 102. When manual control of the autonomous vehicle 102 is passed to the operator, the process can end.

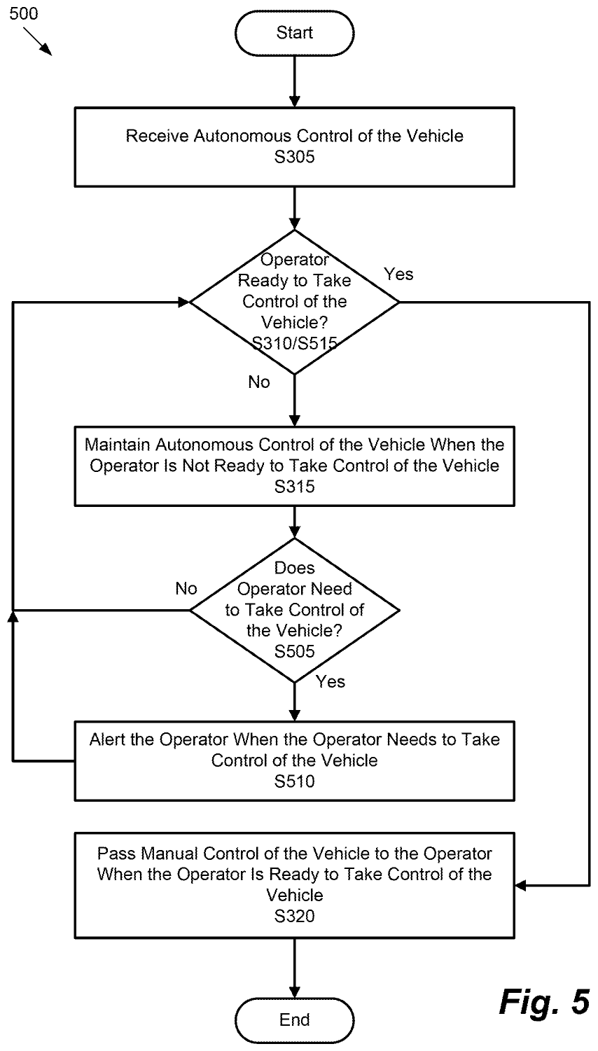

FIG. 5 is an algorithmic flow chart of a method 500 for confirming that a driver has control of a vehicle according to one or more aspects of the disclosed subject matter. In the method 500, S305, S310, S315, and S320 can correspond to the same steps described in FIG. 3.

In S505, it can be determined if the operator of the autonomous vehicle 102 needs to take control of the autonomous vehicle 102. For example, if there is a situation for which the autonomous vehicle 102 needs the operator to take manual control (e.g., unfamiliar traffic pattern, hardware failure, etc.), the autonomous vehicle 102 may alert the operator that the operator needs to take manual control of the autonomous vehicle 102 in S510. If it is determined that the operator does not need to take control of the autonomous vehicle 102, the process can return to S310 to continue the non-intrusive determination of whether or not the operator can take control of the autonomous vehicle 102 as described in method 310 in FIG. 4. However, if it is determined that the operator does need to take control of the autonomous vehicle 102, the processing circuitry 120 can alert the operator of the autonomous vehicle 102 in S510.

In S510, the operator can be alerted through various intrusive techniques when the operator needs to take manual control of the autonomous vehicle 102. For example, various techniques for alerting the operator and gaining the operator's attention can include audio, tactile, and visual techniques. The alert techniques can include playing audio instructions that the operator needs to take manual control of the autonomous vehicle 102. Another example can be blowing air at the operators face (e.g., via the air alert device 215) to gain the attention of the operator. Another technique can be a tactile alert technique to cause one or more components of the autonomous vehicle 102 to vibrate (e.g., seat, steering wheel, seat belt, floor, etc.). Although these techniques are more intrusive compared to the non-intrusive evaluation method describe in method 310, the operator may first need a more intrusive alert described in S510 in certain situations. It should be appreciated that steps S505 and S510 can occur independently or in addition to the non-intrusive evaluation described in S310. For example, when the attention of the operator is gained from the intrusive alert techniques described in S510, the operator may still need to react in the expected way (e.g., S410) before manual control can be passed to the operator. Additionally, the processing circuitry 120 can determine that the operator is fully engaged and ready to take manual control as a result of being alerted in S510. In this case, the processing circuitry 120 can determined that the operator is ready to take manual control of the autonomous vehicle 102 after being alerted in S510 if the operator grasp the steering wheel as indicated by sensors 210a, 210b, for example.

After the operator is alerted in S510, the process can return to S310 to determine if the operator has control of the autonomous vehicle 102. Here, the system 100 can determine if the operator has control of the autonomous vehicle 102 through the non-intrusive evaluation method 310 described in FIG. 4. Alternatively, or additionally, the processing circuitry 120 can determine if the operator is engaged in manual operation of the autonomous vehicle 102 in S515 based on the operator is grasping the steering wheel as determined by sensors 210a, 210b and/or a head position and/or eye position as determined by the imaging device 205. After it is determined that the operator has control of the autonomous vehicle 102 in S310 and/or S515, manual control of the autonomous vehicle can be passed to the operator and the process can end.

In the above description of FIG. 3, FIG. 4, and FIG. 5, any processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

The system 100 includes several advantages including the non-intrusive evaluation system 130. The non-intrusive evaluation system 130 allows the system 100 to determine whether or not the operator is engaged and able to take manual control of the autonomous vehicle 102. Additionally, the non-intrusive evaluation system 130 can be combined with the intrusive evaluation system 140 in certain circumstances to further ensure that the operator can safely take manual control if the operator needs and/or wants to do so.

Additionally, the system 100 significantly increases overall safety by being able to receive autonomous control automatically and not return manual control to the operator of until the operator demonstrates that they are engaged and able to safely take manual control.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. A system configured for confirming that a driver has control of a vehicle, comprising:
processing circuitry configured to
receive autonomous control of the vehicle, wherein the vehicle is capable of autonomous operation,
alert the operator when the operator needs to take manual control of the vehicle,
determine if the operator is ready to take control of the vehicle,
maintain autonomous control of the vehicle when the operator is not ready to take control of the vehicle, and
pass manual control of the vehicle to the operator when the operator is ready to take control of the vehicle.

2. The system of claim 1, wherein the operator is ready to take control of the vehicle when the operator is sufficiently engaged in vehicle operation.

3. The system of claim 2, wherein the processing circuitry is further configured to
control the vehicle in a predetermined driving pattern while the vehicle is being operated autonomously,
determine if the operator reacts in an expected way in response to the vehicle being controlled in the predetermined driving pattern,
maintain autonomous control of the vehicle when the operator does not react in the expected way, and
pass manual control of the vehicle to the operator when the operator does react in the expected way.

4. The system of claim 3, wherein controlling the vehicle in the predetermined driving pattern includes autonomously operating the vehicle in one or more non-intrusive driving patterns.

5. The system of claim 4, wherein the one or more non-intrusive driving patterns includes drifting the vehicle back and forth within a lane that the vehicle is traveling in.

6. The system of claim 4, wherein the one or more non-intrusive driving patterns includes pulsing a braking system of the vehicle.

7. The system of claim 5, wherein the expected way in which the operator reacts includes counteracting the drifting of the vehicle.

8. The system of claim 6, wherein the expected way in which the operator reacts includes accelerating the vehicle.

9. The system of claim 1, wherein autonomous control of the vehicle is received automatically to perform an evasive maneuver in response to detecting a dangerous driving situation that the operator was not sufficiently reacting to while having manual control of the vehicle.

10. The system of claim 1, wherein alerting the operator when the operator needs to take manual control of the vehicle includes one or more of an audio, visual, and tactile alert.

11. A method of confirming that an operator has control of a vehicle, comprising:
receiving, via processing circuitry, autonomous control of the vehicle, wherein the vehicle is capable of autonomous operation;
alerting the operator when the operator needs to take manual control of the vehicle;
determining, via the processing circuitry, if the operator is ready to take control of the vehicle;
maintaining, via the processing circuitry, autonomous control of the vehicle when the operator is not ready to take control of the vehicle; and
passing, via the processing circuitry, manual control of the vehicle to the operator when the operator is ready to take control of the vehicle.

12. The method of claim 11, further comprising:
controlling the vehicle in a predetermined driving pattern while the vehicle is being operated autonomously;
determining if the operator reacts in an expected way in response to the vehicle being controlled in the predetermined driving pattern;
maintaining autonomous control of the vehicle when the operator does not react in the expected way; and
passing control of the vehicle to the operator when the operator does react in the expected way.

13. The method of claim 12, wherein controlling the vehicle in the predetermined driving pattern includes autonomously operating the vehicle in one or more non-intrusive driving patterns.

14. The method of claim 13, wherein the expected way in which the operator reacts includes one or more of counteracting the one or more non-intrusive driving patterns.

15. The method of claim 11, wherein alerting the operator when the operator needs to take manual control of the vehicle includes one or more of an audio, visual, and tactile alert.

16. A non-transitory computer-readable storage medium storing computer-readable instructions that, when executed by a computer, cause the computer to perform a method, the method comprising:
receiving autonomous control of the vehicle, wherein the vehicle is capable of autonomous operation;
determining if the operator is ready to take control of the vehicle;
maintaining autonomous control of the vehicle when the operator is not ready to take control of the vehicle; and
passing manual control of the vehicle to the operator when the operator is ready to take control of the vehicle.

17. The non-transitory computer-readable storage medium of claim 16, further comprising:
controlling the vehicle in a predetermined driving pattern while the vehicle is being operated autonomously;
determining if the operator reacts in an expected way in response to the vehicle being controlled in the predetermined driving pattern;
maintaining autonomous control of the vehicle when the operator does not react in the expected way; and
passing control of the vehicle to the operator when the operator does react in the expected way.

18. The non-transitory computer-readable storage medium of claim 17, wherein controlling the vehicle in the predetermined driving pattern includes autonomously operating the vehicle in one or more non-intrusive driving patterns.

19. The non-transitory computer-readable storage medium of claim 18, wherein the expected way in which the operator reacts includes counteracting the one or more non-intrusive driving patterns.

20. The non-transitory computer-readable storage medium of claim 16, further comprising:
alerting the operator when the operator needs to take manual control of the vehicle.
